(19) United States
(12) Patent Application Publication
(10) Pub. No.: US 2013/0066711 A1
(43) Pub. Date: Mar. 14, 2013

(54) Understanding Effects of a Communication Propagated Through a Social Networking System

(71) Applicants: Janaka Liyanage, Mountain View, CA (US); Neville Bowers, Palo Alto, CA (US); Aldo Ivan King, San Francisco, CA (US); Ami Vora, San Francisco, CA (US); David Gross-Baser, Mountain View, CA (US); Wenrui Zhao, Mountain View, CA (US)

(72) Inventors: Janaka Liyanage, Mountain View, CA (US); Neville Bowers, Palo Alto, CA (US); Aldo Ivan King, San Francisco, CA (US); Ami Vora, San Francisco, CA (US); David Gross-Baser, Mountain View, CA (US); Wenrui Zhao, Mountain View, CA (US)

(73) Assignee: c/o Facebook, Inc., Menlo Park, CA (US)

(21) Appl. No.: 13/229,515

(22) Filed: Sep. 9, 2011

(51) Int. Cl. G06F 15/16; G06Q 30/02

(52) U.S. Cl. 705/14.43; 709/204; 705/14.41; 705/14.52; 705/14.46

(57) ABSTRACT

Effects of content communications propagated to users of a social networking system may be tracked and measured by the social networking system. Identifiers of content presented to a user within a time period prior to an action performed by the user are recorded in a first label object associated with the action. The action performed by the user generates new content to be presented to other users. The identifiers of the new content and the first label object are recorded in new label objects associated with actions performed by the other users subsequent to viewing the new content. Various metrics may be determined by analyzing the label objects associated with actions performed by users of the social networking system, including virality, reach, and identifying users that share a particular content item.

### BACKGROUND

This invention relates generally to social networking, and in particular to tracking effects of a communication in a social networking system.

From billboards on the side of a highway and generic commercials on television and radio, traditional display advertisers have had no way to measure the downstream effects of the ad impressions. Such information may be helpful to advertisers in spending their advertising budgets on advertisements that produce better downstream effects, such as more conversions. Instead, the strategy of this medium of advertising was to inundate consumers with as many brand impressions as possible. This leads to wasteful ad spending.

Online display advertising has improved over traditional display advertising because tracking cookies in users' browsers have enabled tracking of potential customers. For example, as a user browses the Internet from an initial web search, a tracking cookie may record information about advertisements displayed to the user and direct actions taken by the user, such as clicking through an advertisement or sponsored search result. However, this method of tracking click-through behavior produces a limited viewpoint as to what caused the user to perform the click. The actions may only be attributed to the advertisement through which the user performed the click. Other actions, such as visiting a website regarding the content of the presented advertisements, may not be attributed to the advertisement.

In recent years, users of social networking systems have shared their interests and engaged with other users of the social networking systems by sharing photos, real-time status updates, and playing social games. The amount of information gathered from users is staggering—information about news articles, videos, photos, and game achievements shared with other users of the social networking system. Certain content posted to a social networking system may become “viral” in the sense that users become more likely to share the content with other users of the social networking system. Social networking systems have lacked the tools to measure the “virality” of a content item as well as other metrics that may be useful for advertisers in designing social media advertising campaigns.

Specifically, social networking systems have not been able to track effects of a content impression on users. Mechanisms to determine downstream effects, such as users engaging with a brand page, clicking through to an external website, and checking in to a physical location associated with a brand, have not been created. Advertisers as well as administrators of social networking system would benefit from knowing these downstream effects of content presented to users for targeting criteria and providing more relevant content to users.

### SUMMARY

Effects of content communications propagated to users of a social networking system may be tracked and measured by a social networking system. Identifiers of content presented to a user within a time period prior to an action performed by the user are recorded in a first label object associated with the action. The action performed by the user generates new content to be presented to other users. The identifiers of the new content and the first label object are recorded in new label objects associated with actions performed by the other users subsequent to viewing the new content. Various metrics may be determined by analyzing the label objects associated with actions performed by users of the social networking system, including virality, reach, and identifying users that share a particular content item.

### BRIEF DESCRIPTION OF THE DRAWINGS

FIG. 1A is a block diagram illustrating a process of tracking a content impression being propagated in a social networking system, in accordance with an embodiment of the invention.

FIG. 1B is a block diagram illustrating a process of attributing actions performed by users of a social networking system to a content impression, in accordance with an embodiment of the invention.

FIG. 2 is a network diagram of a system for tracking effects of a communications propagated in a social networking system, showing a block diagram of the social networking system, in accordance with an embodiment of the invention.

FIG. 3 is a flowchart of a process for labeling actions performed by users of a social networking system with content provided to the users prior to the actions, in accordance with an embodiment of the invention.

FIG. 4 is a flowchart of a process for attributing actions performed by users of a social networking system to a content item previously provided to a user before the actions, in accordance with an embodiment of the invention.

FIG. 5 is a block diagram illustrating a metrics analysis module that includes various modules for determining metrics of content and users in a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, shared content items, and potential friends to a user. The social networking system may also use user profile information to direct advertisements to the user, ensuring that only relevant advertisements are directed to the user. Relevant advertisements ensure that advertising spending reaches their intended audiences, rather than wasting shrinking resources on users that are likely to ignore the advertisement.

In addition to declarative information provided by users, social networking systems may also record users' actions on the social networking system. These actions include communications with other users, sharing photos, interactions with applications that operate on the social networking system, such as a social gaming application, responding to a poll, adding an interest, and joining an employee network. A social networking system may also be able to capture external website data that is accessed by its users. This external website data may include websites that are frequently visited, links that are selected, and other browsing data. Information about users, such as stronger interests in particular users and applications than others based on their behavior, can be generated from these recorded actions through analysis and machine learning by the social networking system.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plugin, programmable logic or code snippet into the web pages, such as an iFrame. Any concept that can be embodied in a web page may become a node in the social graph on the social networking system in this manner. As a result, users may interact with many objects external to the social networking system that are relevant to a keyword or keyword phrase, such as “Justin Bieber.” Each of the interactions with object may be recorded by the social networking system as edges. Enabling third-party developers to define custom object types and custom action types is described further in “Structured Objects and Actions on a Social Networking System,” U.S. Application No. XX/YYY,YYY filed on ______, which is hereby incorporated by reference.

User generated content, such as photos, videos, textual status updates, links to websites and user actions within and outside of a social networking system, may be shared by users with other users of a social networking system. As a result, certain content items may be shared repeatedly among users of the social networking system. These “viral” content items may include any type of user generated content as well as advertisements shared by users of the social networking system. Content items may become “viral” in the sense that users are more likely to share the content items than other content items. “Virality” of content items may be determined as a measure of how often content items were exposed to users in comparison to other content items in a given time period, in one embodiment. Traditionally, the virality of content items may be determined by observing the distribution of content items and patterns of content spread within a given time period.

Content items may encourage users to perform certain actions on objects within a social networking system, such as “liking” a page on the social networking system that results in generating a connection between the user and the page on the social networking system, sharing a content item with other users of the social networking system, and commenting on the content item. Each action performed by a user of a social networking system may be published as a new content item on the social networking system. These new content items may be described as “stories” in the sense that the content item describes the action performed by the user. As a result, actions performed by users of a social networking system may be attributable to content items presented to the users prior to performing the actions. In traditional media, attribution of actions to content that was presented to a user, such as an advertisement for shoes, could not be determined. However, a social networking system may now determine whether an action may be attributed to a particular content item, such as an advertisement, by labeling the action with identifiers of the content items that were presented to the user prior to the action.

Significant resources must be expended to organize the staggering amounts of data collected in tracking causation of user actions on a social networking system. A social networking system having hundreds of millions of users, for example, gathers and infers a staggering amount of information about its users. To address issues of scalability and efficiently expending computing resources, a social networking system may utilize efficient mechanisms for handling large databases.

Reliable information about how users were influenced to perform certain actions and what content items were presented to those users is valuable to administrators of a social networking system because this information may be used, in one embodiment, to price advertisements. For example, the pricing of an advertisement may depend on a metric based on the number of impressions made on downstream users. Other metrics may be determined from the information gathered about content item impressions presented to users, such as probabilities that users would interact with the advertisement, check-in to a location associated with the advertisement, and express an interest in a page on the social networking system associated with the advertisement. These probabilities may be determined based on data gathered from tracking content items presented to users prior to actions performed by the users. Such information would provide advertisers with a better understanding of how effective impressions were in producing a beneficial outcome, such as increased engagement with a brand and bringing users to a physical location associated with the advertisement.

Attribution of which content impression, such as an advertisement or a content item posted on a social networking system, caused a user action may be determined by various methods. In one embodiment, the last impression made on the user related to the user action may be the attributed content item impression for the user action. In another embodiment, the first impression made on a user connected to the user performing the action may be attributed as the content item impression that caused the user action. Machine learning, heuristics analysis, and statistical analysis may be used in attributing causation of a user action to a content impression.

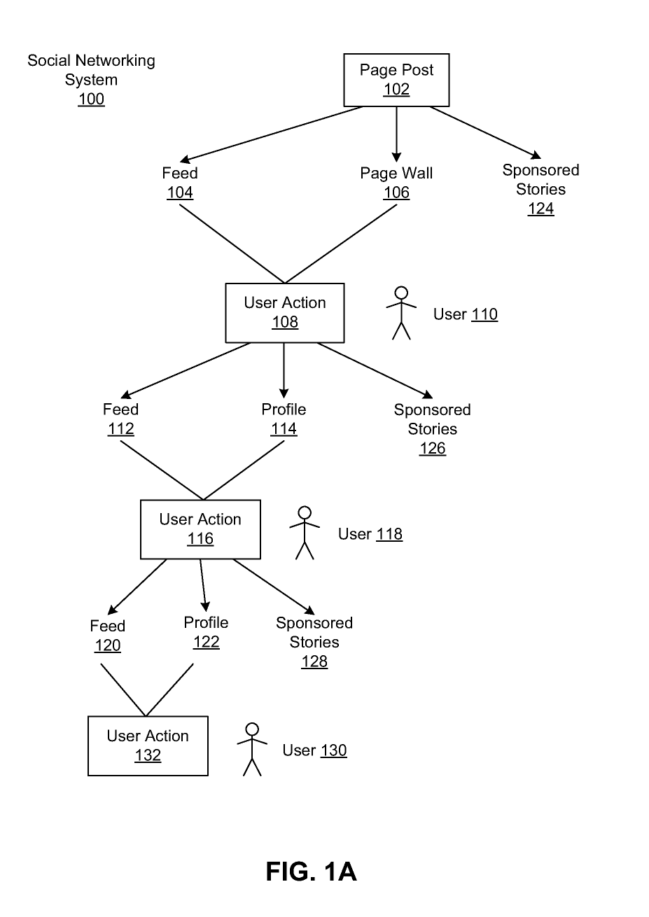

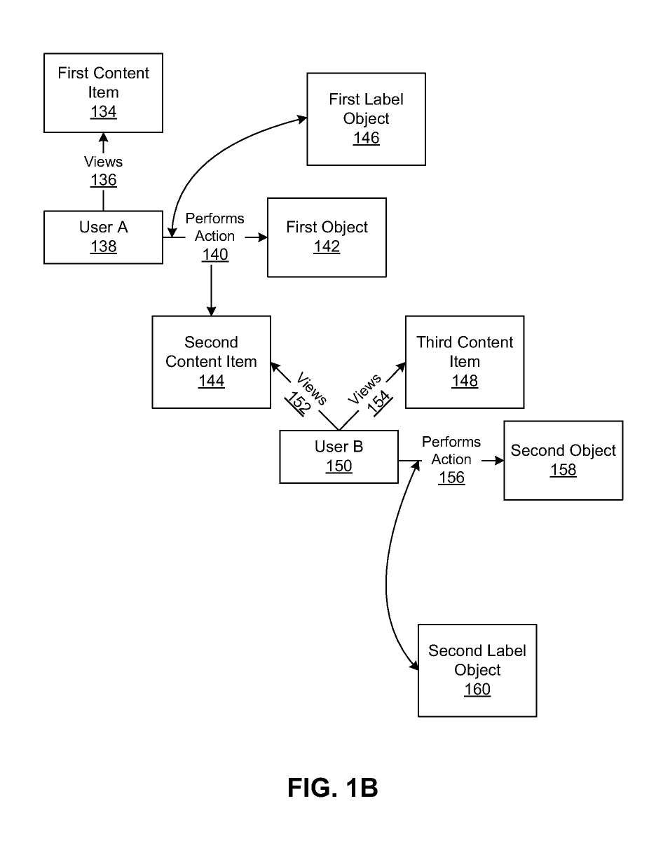

FIG. 1A illustrates a block diagram of a process for tracking a content impression being propagated in a social networking system, in one embodiment. In this diagram, downstream effects of a communication, such as a page post 102, are illustrated. Users of the social networking system 100 may take actions using the social networking system 100 that are associated with one or more objects. Many different types of interactions may occur on a social networking system, including commenting on a photo album, communications between users, becoming a fan of a musician, and adding an event to a calendar. User may also perform actions with advertisements on the social networking system 100 as well as other applications operating on the social networking system 100. These actions may be published as communications in the social networking system 100 through different communication channels, including a feed 104, a page wall 106, and sponsored stories 124. For purposes of tracking content impressions to calculate total reach of a content impression, interactions with sponsored stories are easily counted because these content impressions are paid for by advertisers. Communications presented through the feed 104 and the page wall 106 represent organic distribution points that enable users to share content items, including user actions, to other users.

In a first generation of communication, a page post 102 communicated via these communication channels may reach a user 110 depending on whether the user 110 has previously connected to the page associated with the page post 102 or whether the user 110 independently browsed the page wall 106 associated with the page. Subsequent to viewing the page post 102, the user 110 may perform an user action 108, such as commenting on the page post 102, sharing the page post 102 with other users, expressing an interest in the page associated with the page post 102, performing a custom action associated with the page associated with the page post 102, clicking a link within the page post 102, checking in to a location associated with the page post 102, and even performing an action unrelated to the page post 102. Regardless of the type of user action 108 performed by the user 110, the social networking system 100 may track identifiers of the content that was provided to the user 110 prior to the user action 108. Here, the tracked content includes the page post 102. The tracked content may be stored as a label associated with the user action 108.

In a second generation of communication, the user action 108 performed by the user 110 may be published in various communication channels, including a feed 112, a profile 114 associated with the user 110 and sponsored stories 126. The feed 112 includes a stream of communication that includes communications made by the user 110. For example, a user 118 connected to the user 110 may receive the user action 108 as a content item in the feed 112 because the user 118 is connected to the user 110. The profile 114 associated with the user 110 may include communications made by the user 110 on the social networking system 100. The user 118, in another example, may not be connected to the user 110 and may view the user action 108 on the profile 114 associated with the user 110 by browsing publicly available information on the social networking system 100. The first generation of communication influences the second generation of communication. In other words, the page post 102 caused the user action 108 which was then communicated to the user 118.

The user 118 may then perform a user action 116, such as commenting on the user action 108, sharing the user action 108, and expressing an interest in the user action 108. The social networking system 100 may again track identifiers of the content that was provided to the user 118 prior to the user action 116. Here, the tracked content includes the user action 108. The tracked content associated with the user action 116 includes the user action 108 and the label associated with the user action 108. This tracked content is stored in a label associated with the user action 116.

In a third generation of communication, the user action 116 may be published as a communication in a feed 120, a profile 122 associated with the user 118, and as sponsored stories 128 in the social networking system 100. A user 130 may view the user action 116 as a content impression and subsequently perform a user action 132 that may or may not be related to the user action 116. The social networking system 100 may track content provided to the user 130 prior to the user action 132. This tracked content includes the user action 116 as well as the label associated with the user action 116 and is stored in a label associated with the user action 132.

Because of the referential nature of the labels associated with the user actions, the tracked content for the user actions in the first, second, and third generations may be accessed such that the user action 132 produced in the third generation of communication may be attributable to the page post 102 in the first generation of communication. Thus, in the attribution process for the user action 132, the page post 102 may emerge as the content impression that caused the user action 132. FIG. 1A only illustrates one user for each generation of communication, yet a social networking system that includes millions of users may have hundreds or even thousands of users at each generation. Additionally, labels associated with user actions may include content impressions in a predetermined time period before the user actions were performed. The time period may vary depending on the type of action. For example, a check-in to a specific location may include tracked content that was provided within 24 hours of the check-in, whereas an expressed interest in a page on the social networking system may include tracked content that was provided within a week of the expressed interest.

While FIG. 1A illustrates downstream effects of a communication in a social networking system, FIG. 1B illustrates how a social networking system may track content impressions that cause the downstream user actions, in one embodiment. A first content item 134 may be published by the social networking system 100. For example, administrators of a page on the social networking system 100 may post a special promotion informing users of free ice cream at local stores by checking-in. User A 138 may view 136 the first content item 134, such as the promotion on the page of the social networking system 100, through an organic distribution point in a communication channel on the social networking system 100. Subsequently, user A 138 performs an action 140 on a first object 142 in the social networking system 100. The action 140 performed by the user A 138 on a first object 142 may be the user A 138 expressing an interest in the page associated with the promotion, for example.

The performance of the action 140 generates a second content item 144 in the social networking system 100. Additionally, the social networking system 100 generates a first label object 146 associated with the performed action 140, or an edge created between the user A 138 and the first object 142. The first label object 146 associated with the performed action 140 includes content impressions on the user A prior to the performance of the action 140. Here, the first label object 146 includes the view 136 of the first content item 134. In one embodiment, the first label object 146 includes the time stamp of the view 136 and identifying information about the first content item 134.

The second content item 144 may be viewed by other users in the social networking system 100. In reference to FIG. 1A, the second content item 144 may be communicated to other users of the social networking system 100 in a second generation of communication. User B 150 may view 152 the second content item 144. Additionally, the user B 150 may view 152 a third content item 148. Subsequent to those content impressions, the user B 150 performs an action 156 on a second object 158. The social networking system 100 generates a second label object 160 in association with the performance of the action 156 by the user B 150 on the second object 158. The second label object 160 includes information about the second content item 144 and the third content item 148 that the user B 150 viewed prior to the action 156. Because the second content item 144 was generated from the performed action 140 associated with the first label object 146, the second label object 160 also includes the first label object 146.

Returning to the above example regarding the ice cream promotion, user B 150 may have viewed user A 138′s expressed interest in the page associated with the ice cream promotion. Additionally, user B 150 may have also viewed a status update from a friend about enjoying a sunny day in the park. User B may then perform a check-in to a local ice cream store to redeem the ice cream promotion in person. The action of checking in to a physical location by user B 150 corresponds to the action performed 156 on the second object 158.

An attribution process may analyze the content items that were provided on the social networking system 100 that may have caused the action performed 156 by the user B 150 on the second object 158. In order to identify these content items, the attribution process uses the second label object 160 associated with the action performed 156. As mentioned above, the second label object 160 includes the first label object 146. Because of the referential nature of label objects, information within the first label object 146 may be accessed by the attribution process, and the first content item 134 may be identified as a potential content item to attribute the performed action 156. Thus, the attribution process may subsequently determine that user A 138′s viewing 136 of the first content item 134 was the first impression that caused user B 150 to perform the action 156 on the second object 158. As a result, in this example, administrators of the social networking system 100 may attribute user B′s check-in to the ice cream store to the post on the page associated with the ice cream store promoting the free ice cream store that was viewed by user A.

As illustrated in FIG. 1B, connections between objects, or edges between nodes, in a social networking system 100 may be formed as users perform actions on objects. Though not illustrated in FIG. 1B, edge objects store information about users' connections on a social networking system 100. Such information may include the interactions between the user and other objects on the social networking system 100, including wall posts, comments on photos, geographic places, and tags in photos. Label objects may be associated with edge objects that are created as a result of the actions performed on objects. In one embodiment, an edge object includes information about the strength of the connection between the nodes, such as an affinity score. If a user has a high affinity score for a particular object, the social networking system 100 has recognized that the user interacts highly with that object. Label objects associated with edge objects that have high affinity scores may, in one embodiment, be weighted in determining attribution of a user action.

Attribution of user actions may be determined using a scoring model that includes rules and weighted factors in selecting content items. In one embodiment, the content item that was last clicked on is attributed to the subsequent user action. In another embodiment, the content item that was first viewed is attributed to the subsequent user action. Various metrics may be determined based on the information tracked in the label objects associated with actions performed by users of the social networking system 100, such as a virality metric that measures the likelihood of a user sharing a content item, a reach metric that measures the number of people who have viewed a content item, a conversion metric that measures the number of conversions of a content item, and a storyteller metric that measures the number of users who created an edge with a certain object.

### System Architecture

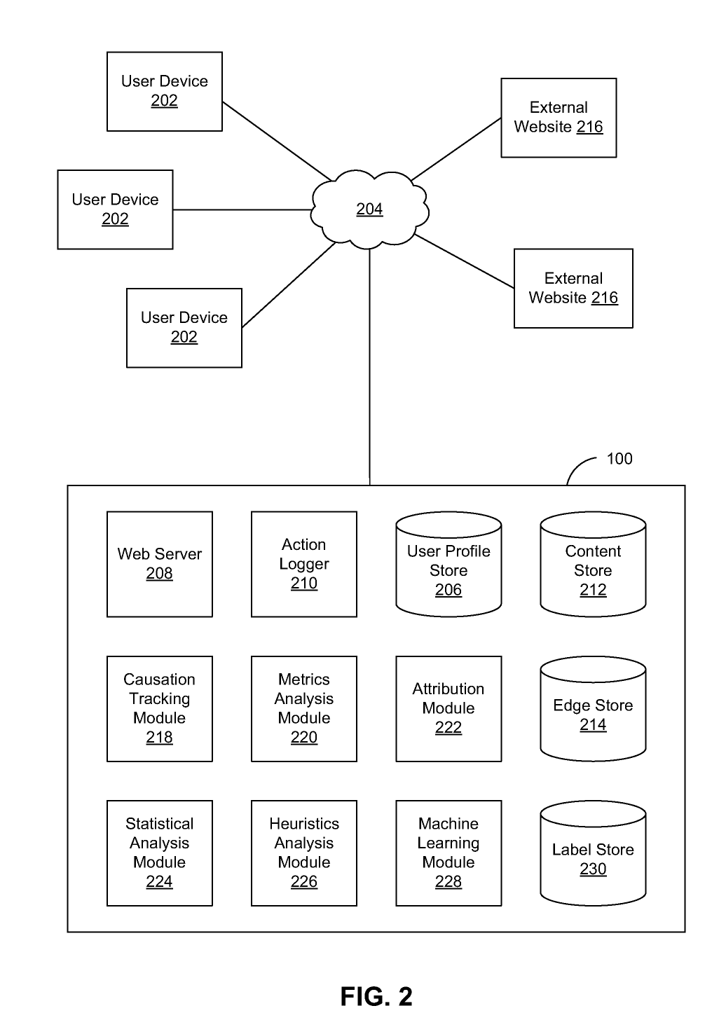

FIG. 2 is a block diagram illustrating a system environment suitable for tracking effects of a communications propagated in a social networking system, in accordance with an embodiment of the invention. The system environment comprises one or more user devices 202, the social networking system 100, a network 204, and one or more external websites 216. In alternative configurations, different and/or additional modules can be included in the system.

The user devices 202 comprise one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, etc. The user device 202 is configured to communicate via network 204. The user device 202 can execute an application, for example, a browser application that allows a user of the user device 202 to interact with the social networking system 100. In another embodiment, the user device 202 interacts with the social networking system 100 through an application programming interface (API) that runs on the native operating system of the user device 202, such as iOS 4 and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes a user profile store 206, a web server 208, an action logger 210, a content store 212, an edge store 214, a label store 230, a causation tracking module 218, a metrics analysis module 220, an attribution module 222, a statistical analysis module 224, a heuristics analysis module 226, and a machine learning module 228. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 via the network 204 to one or more user devices 202; the web server 208 serves web pages, as well as other web-related content, such as Java, Flash, XML, and so forth. The web server 208 may provide the functionality of receiving and routing messages between the social networking system 100 and the user devices 202, for example, instant messages, queued messages (e.g., email), text and SMS (short message service) messages, or messages sent using any other suitable messaging technique. The user can send a request to the web server 208 to upload information, for example, images or videos that are stored in the content store 212. Additionally, the web server 208 may provide API functionality to send data directly to native user device operating systems, such as iOS, ANDROID, webOS, and RIM.

Label objects are generated by the causation tracking module 218 in the social networking system 100. These label objects are stored in the label store 230. An attribution module 222 analyzes a label object associated with a user action recorded by the action logger 210 of the social networking system 100 to determine an attribution for the user action. User actions are stored as edge objects in the edge store 214. The attribution module 222 may determine the attribution for a user action based on the content item objects identified in the label object associated with the edge object for the user action. The metrics analysis module 220 may determine metrics based on analysis of label objects, user profile objects, and content objects in the social networking system 100 in coordination with the statistical analysis module 224, the heuristics analysis module 226, and the machine learning module 228.

The action logger 210 is capable of receiving communications from the web server 208 about user actions on and/or off the social networking system 100. The action logger 210 populates an action log with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log may be used by a social networking system 100 to track users' actions on the social networking system 100 as well as external websites that communication information back to the social networking system 100. As mentioned above, users may interact with various objects on the social networking system 100, including commenting on posts, sharing links, and checking-in to physical locations via a mobile device. The action log may also include user actions on external websites. For example, an e-commerce website that primarily sells luxury shoes at bargain prices may recognize a user of a social networking system 100 through website plug-ins that enable the e-commerce website to identify the user. Because users of the social networking system 100 are uniquely identifiable, e-commerce websites, such as this luxury shoe reseller, may use the information about these users as they visit their websites. The action log records data about these users, including viewing histories, advertisements that were clicked on, purchasing activity, and buying patterns.

User account information and other related information for a user are stored in the user profile store 206. The user profile information stored in user profile store 206 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. A user profile store 206 maintains profile information about users of the social networking system 100, such as age, gender, interests, geographic location, email addresses, credit card information, and other personalized information. The user profile store 206 also maintains references to the actions stored in the action log and performed on objects in the content store 212.

The edge store 214 stores the information describing connections between users and other objects on the social networking system 100. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge store 214 stores edge objects that include information about the edge, such as affinity scores for objects, interests, and other users.

A causation tracking module 218 generates label objects associated with edge objects for user actions. The label objects include identifiers for content item objects that were presented to the user performing the actions in a time period prior to the actions as illustrated in FIGS. 1A & 1B. The causation tracking module 218 may utilize a different time period for different types of actions, in one embodiment. For example, a time period of one week may be used for a check-in event at a geographic location created by a user device 202 while a time period of 24 hours may be used for a click-through by a user device 202 of an advertisement shared by another user of the social networking system 100.

In generating a new label object, the causation tracking module 218 also includes other label objects associated with edge objects that are associated with content item objects presented to the user. As a result, if a prior content item object was generated as a result of a prior user action and the prior content item object was provided to the user before the user performed the action associated with the new label object, then the old label object associated with the prior user action is included in the new label object by the causation tracking module 218.

A metrics analysis module 220 may determine various metrics using the information gathered by the label objects generated by the causation tracking module 218. A social networking system 100 may use the metrics analysis module 220 to provide advertisers with metrics information that may warrant higher or discounted pricing models for advertisements. Such metrics may include virality metrics, reach metrics, engagement metrics, conversion metrics, location metrics, and storyteller metrics. Virality metrics may include measurements of how quickly a content item was distributed throughout the social networking system, the replication rate of content items over time, virality rates of content items, and comparison of virality metrics of multiple content items in a single advertising campaign. Reach metrics may be determined for content items to approximate the number of unique users that viewed the content item. These reach metrics may be segmented based on demographics, geographic location, types of user actions, interests of users, and other user characteristics. Engagement metrics may be determined based on the causation tracking information gathered from label objects associated with user actions, including levels of user engagement with the social networking system based on the virality of content items shared by users, how users were influenced to interact with content items based on connected users interacting with the content items, and how often users repeatedly interacted with highly-viral content items.

Conversion metrics may be determined based on information gathered from external websites that indicate users completing transactions on external websites. Metrics may be determined to attribute conversions on external websites to advertisements on the social networking system 100. Location metrics may be determined to track how many users may have been influenced to perform a check-in event at a physical location associated with an advertisement, which content items may have caused users to perform the check-in event, and geographic locations where users actively use the check-in feature on the social networking system 100. A storyteller metric provides information about users that have created an edge with an object in the social networking system 100. Thus, the number of users who have generated an edge about the advertisement may be provided to advertisers as a storyteller metric.

An attribution module 222 may use several rules and weighted factors in a scoring model to select content items for attributing user actions. In one embodiment, administrators of the social networking system 100 may heavily weight the most recent click of an advertisement in determining attribution for user actions. In another embodiment, the first impression of a content item that is relevant to a user action may be selected for attribution. Relevance of a content item to a user action may be determined using the statistical analysis module 224 to yield probabilities of relevance. In yet another embodiment, a scoring model may be used to score candidate content items for attributing a user action. Factors, such as relevance of the content item, age of the content item, and whether the content item is associated with a prior user action, may be weighted in the scoring model to select the best content item for attribution. The weights may be initially assigned by administrators of the social networking system 100 and may be adjusted over time based on feedback and results of machine learning. Regression analysis may also be used to optimize weights in the scoring model, in one embodiment.

A statistical analysis module 224 may be used in conjunction with other modules in the social networking system 100 to track causation of user actions. For example, statistical analysis may be used to determine probabilities for attribution based on relevance of the content item with the user action in conjunction with the attribution module 222. Statistical analysis may also be used in determining probabilities of conversions, engagement, and check-in events by users for a content item based on prior information gathered about similar content items in conjunction with the metrics analysis module 220.

A heuristics analysis module 226 may be used by modules of the social networking system to analyze characteristics of objects, users, and behavior patterns. For example, heuristics analysis of the popularity of a content item, based on the number of times it has been viewed, may be used to determine whether the content item should be selected for attribution. Heuristics analysis may also be used in approximating various metrics about the information tracked by the social networking system 100, such as correlating behavior on the social networking system 100 to behavior on external websites 216. For example, an advertisement may be provided to a first user on the social networking system 100 promoting a special content to win Britney Spears concert tickets which the user subsequently clicks on. The click-through may take the first user to a page on the social networking system 100 associated with Britney Spears. The first user may then express an interest in the page and generate a content item on the page. The content item may then be shared with other users on the social networking system that have also expressed an interest in the page.

The first user may then follow a link to an external website 216 to enter the Britney Spears concert tickets giveaway contest. A tracking pixel on the external website 216, in one embodiment, may provide information to the social networking system 100 that the first user entered the contest on the external website 216. The attribution module 222, in conjunction with the heuristics analysis module 226, may then attribute the offsite behavior, the entry into the tickets giveaway contest on the external website 216, to the advertisement provided to the first user on the social networking system 100. A second user may view the content item generated by the first user on the page on the social networking system 100. As a result, the second user may be counted by the metrics analysis module 220, in conjunction with the heuristics analysis module 226, as a user that was reached by the advertisement originally provided to the first user on the social networking system 100 because the second user's entry into the contest may be attributed to the generated post by the first user, and that post may be attributed to the advertisement provided to the first user. Thus, the heuristics analysis module 226 may enable the social networking system 100 to connect the dots between user behavior on the social networking system 100 and user behavior outside of the social networking system 100 on external websites 216.

In one embodiment, third-party developers may use custom action types and custom object types to report custom actions performed by users on custom objects on websites external to the social networking system 100. For example, an e-commerce retailer may report to the social networking system 100 that a user performed a “purchase” action on a “book” object. If there was a content item that was viewed or interacted with by the user related to an entity on the social networking system related to the e-commerce retailer, the action may be attributed to that content item via the attribution module 222 in conjunction with the heuristics analysis module 226. In this way, offsite behavior, captured by the social networking system 100 using custom action types and custom object types, may be attributed to onsite behavior.

A machine learning module 228 may be used in conjunction with other modules of the social networking system 100 to train various models based on information received. In one embodiment, machine learning may be used to determine whether an attribution of a user action to a content item was correct using user feedback. In another embodiment, machine learning may be used to optimize weights in a scoring model for the attribution module 222 based on usage of the scoring model. In yet another embodiment, a social networking system 100 uses a machine learning algorithm to analyze the conversion rates of targeted advertising to retrain a model of determining probabilities for attribution of candidate content items.

### Causation Tracking Using Labels

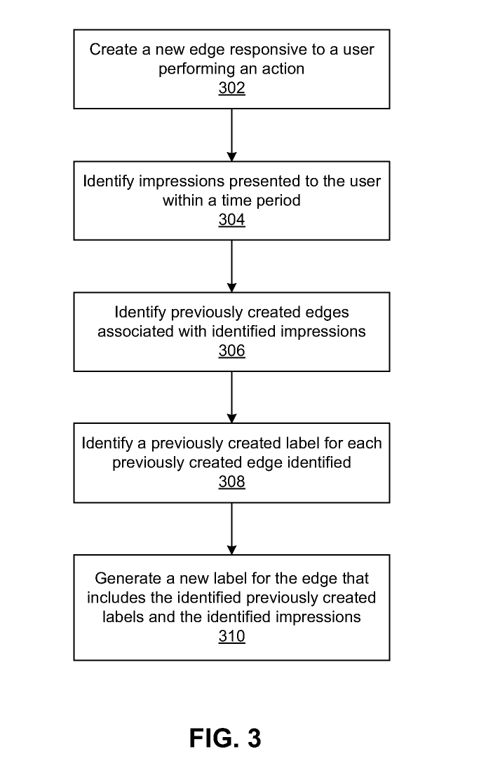

FIG. 3 illustrates a flow chart diagram depicting a process of labeling actions performed by users of a social networking system with content provided to the users prior to the actions, in accordance with an embodiment of the invention. In one embodiment, the steps illustrated in FIG. 3 are performed by the causation tracking module 218. In response to a user performing an action, a new edge is created 302. The new edge may be stored as an edge object in the edge store 214. In one embodiment, the new edge may be created 302 immediately after the action is performed by the user, in real-time. In another embodiment, the new edge may be created 302 as part of a batch process that analyzes an action log populated by the action logger 210.

After the new edge has been created 302, impressions presented to the user within a time period are identified 304. Impressions may include content items provided on the social networking system 100, such as status updates, photos, videos, links, application-generated communications such as game achievements, and advertisements. In one embodiment, the time period is a pre-determined length of time for all types of actions. In another embodiment, the time period may vary depending on the type of action. For example, a check-in event at a real-world geographic location may have a week-long time period, whereas a click on a content item may have a 24-hour time period.

After the impressions are identified 304, previously created edges associated with the identified impressions are identified 306. For example, a content item that was viewed by the user may have been generated as a result of an action performed on an object in the social networking system 100, such as a user writing a post on another user's wall, a comment made by a user on a link shared by another user, a gaming application posting a content item that illustrates an achievement gained by a user in the game, and so forth. Other content items, such as advertisements and page posts, may not have edges associated with the impression. The edges may be identified by searching the edge store 214 using identifiers of the content objects in the identified impressions, in one embodiment. In another embodiment, the edges may be identified by searching the content store 212 for edges associated with the identified content objects that were identified as impressions.

Once the previously created edges are identified 306, a previously created label is identified 308 for each previously created edge. Previously created labels associated with previously created edges may be identified 308 from label objects stored in the label store 230. A new label is then generated 310 for the newly created edge as a label object and stored in the label store 230. The new label includes the identified previously created labels associated with the identified previously created edges associated with the identified impressions as well as the identified impressions.

### Attribution of User Actions to Content Items Provided in the Social Networking System

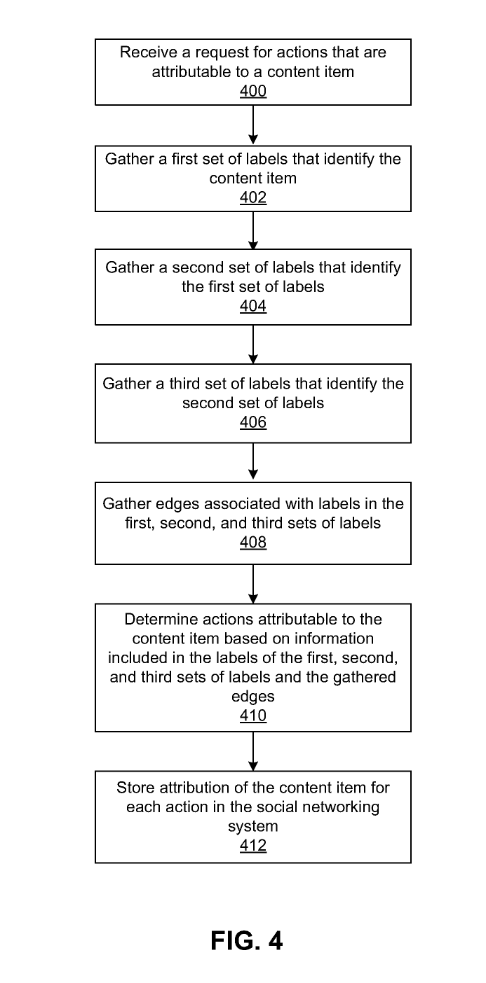

FIG. 4 is a flowchart diagram depicting a process of attributing actions performed by users of a social networking system to a content item previously provided to a user prior to the actions, in accordance with an embodiment of the invention. A request for actions that are attributable to a content item is received 402 by the attribution module 222, in one embodiment. In another embodiment, the request for attribution is received 402 by the social networking system 100 from an external system via the network 204. The content item may include advertisements, page posts, status updates, shared links, and the like. The request may include an identifier of the content item, in one embodiment.

A first set of labels that identify the content item is gathered 402 by searching the label store 230 for label objects that include the identifier of the content item. For example, an advertisement for shoedazzle.com may be the content item that is being requested for attribution. The attribution module 222 queries the label store 230 for the identifier of the advertisement for shoedazzle.com. The results of the query include label objects that have the identifier of the advertisement as an impression that was recorded after an action was performed.

A second set of labels that identify the first set of labels is gathered 404 by searching the label store 230 for label objects that reference a label in the first set of labels. Continuing the example, the first set of label objects that include the identifier of the advertisement for shoedazzle.com may be searched for in the label store 230. The results of the search include a second set of label objects where each label object in the second set of label objects includes at least one label object contained in the first set of label objects. Suppose that Jane, a user of the social networking system 100, viewed the advertisement for shoedazzle.com and subsequently clicked on the advertisement, presenting the page for shoedazzle.com to Jane. Jane may then express an interest in the page and then share the page with other users connected to Jane on the social networking system 100. Keith, a user connected to Jane on the social networking system 100, may view the shared page for shoedazzle.com and also express an interest in the page. In this example, a first set of label objects would have been created by Jane's actions, including Jane's click on the advertisement, Jane's expression of interest in the page, and Jane's sharing of the page with her connected users on the social networking system 100. A second set of label objects would include a label object for Keith's expression of interest in the page because the label object for Keith's expression of interest in the page would include the label object for Jane's sharing of the page with her connected users on the social networking system 100.

A third set of labels that identify the second set of labels may then be gathered 406 by searching the label store 230 for label objects that reference a label in the second set of labels. The results of the search include a third set of label objects where each label object in the third set of label objects includes at least one label object contained in the second set of label objects. In one embodiment, labels are gathered in this manner until no more labels can be gathered. In another embodiment, the social networking system 100 may impose a limit on the number of labels that are gathered. In yet another embodiment, the social networking system 100 may gather a predetermined number of sets of labels. Continuing the example, references to the label object for Keith's expression of interest in the page is queried in the label store 230. The third set of labels, in this example, is an empty set.

Next, edges associated with labels in the first, second, and third sets of labels are gathered 408 by retrieving edge objects from the edge store that are associated with the label objects in the first, second, and third sets of labels. The edge objects include information about edges that represent users performing actions on objects in the social networking system 100 as well as external websites 216. Edges may represent any action that may be performed on the social networking system 100, such as posting a status update, photo tagging, video uploading, sharing links, installing an application, expressing interest in a page, expressing interest in a comment, and the like. Edges may also represent a custom action that was performed on an external website, such as listening to a song, reading a news article, or playing a game. In an alternate embodiment, the edges associated with labels in the first set of labels are gathered 408 by retrieving edge objects from the edge store that are associated with the label objects in the first set of labels.

Actions attributable to the content item may be determined 410 based on information included in the labels of the first, second, and third sets of labels and the gathered edges. The information included in the labels and the gathered edges include identifiers of content items, user identifiers of the users performing the actions associated with the edges, and object identifiers of the objects on which the actions were performed. From this information, the attribution module 222 may determine actions that meet attribution criteria. Such criteria may include whether the action was performed within the time period associated with the type of action, such as a check-in event at a geographic location performed within a week of the content item being posted and a mention of a page in a status update performed within 24 hours of the content item being posted. Other criteria may include whether an action is already attributed to a different content item, whether the content item was last clicked by the user performing the action, and whether the content item was the first viewed by the user performing the action. Various types of actions may meet the attribution criteria, such as purchasing a deal on the social networking system, sharing content items, as well as custom action types like reading a book, listening to music, and running a marathon. In one embodiment, an action attributable to the content item may be determined 410 based on whether an entity associated with creating the content item is also associated with an object representing a conversion.

The attribution of the content item for each action is stored 412 in the social networking system 100. In one embodiment, the attribution is stored 412 in the associated edge for the action. In another embodiment, a content object is stored 412 in the content store 212 for the content item such that fields in the content object include the information of the determined actions attributable to the content item.

### Providing Metrics Regarding Tracked Content in a Social Networking System

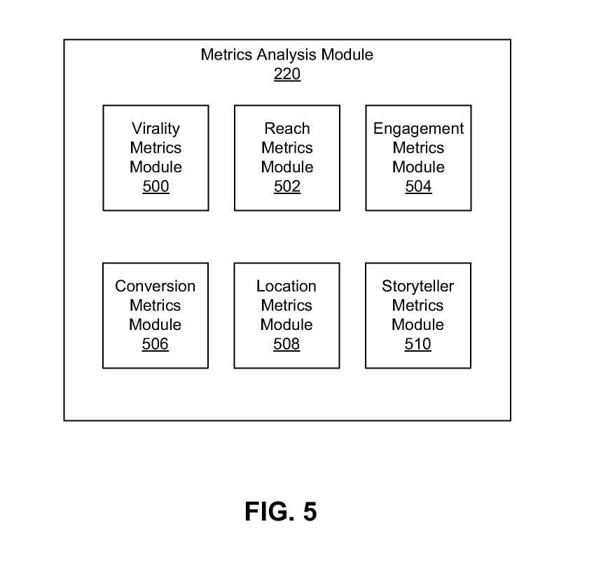

FIG. 5 is a high-level block diagram of the metrics analysis module 220 in further detail, in one embodiment. The metrics analysis module 220 includes a virality metrics module 500, a reach metrics module 502, an engagement metrics module 504, a conversion metrics module 506, a location metrics module 508, and a storyteller metrics module 510. These modules may perform in conjunction with each other, independently, or with other modules in the social networking system to provide metrics for tracked content.

The virality metrics module 500 gathers information from the generated label objects in the label store 230 and provides virality metrics. One type of virality metric may include a virality rate. In one embodiment, a virality rate may be measured as the ratio of one generation's reach to the previous generation's reach. Reach may be defined as the number of users that viewed a content item. A generation may be defined as a group of users at one stage of viral infection. For example, an advertisement may be provided on a social networking system 100 for viewing by a first generation of users. The first generation of users may then perform actions related to the advertisement that are shared with a second generation of users. Referring to FIG. 1A, the first generation of users received a first generation of communication, such as the page post 102 being provided to the user 110 via the feed 104 or the page wall 106. The second generation of users received a second generation of communication, such as the user action 108 performed by the user 110 and provided to the user 118 via the feed 112 or the profile 114. The reach of the first generation of communication, the page post 102 communicated via the feed 104 or the page wall 106, is the number of users that viewed the page post 102. This reach includes user 110. The reach of the second generation of communication, the user action 108 communicated via the feed 112 or the profile 114, is the number of users that viewed the user action 108. This reach includes user 118. In another embodiment, the virality rate may be measured as a ratio of the total reach of all generations to the first generation's reach. As a result, the social networking system 100 may provide a virality rate of a content item to advertisers for tracking the effectiveness of viral advertising campaigns.

The reach metrics module 502 measures reach of content items across generations of communications in a social networking system 100. The reach metrics module 502 may measure reach of a content item in conjunction with the attribution module 222 determining attribution of user actions to content items. For example, an advertisement about shoedazzle.com may have a total reach several generations deep, such that the reach of the advertisement may include the number of users that expressed interest in a page associated with shoedazzle.com, a number of users that made purchases on shoedazzle.com, a number of users that shared links to shoedazzle.com, a number of users that made posts on users' profiles mentioning the page associated with shoedazzle.com, and so forth. Reach may be segmented by types of action, may be provided by generation of communication, or may be provided as a total number of users reached according to attributed user actions.

The engagement metrics module 504 measures user engagement with content items with added information from the generated label objects in the label store 230. In one embodiment, the engagement metrics module 504 may measure a user's engagement with the social networking system 100 based on the number of content items shared by the user as well as the virality of those content items. The engagement metrics module 504 may analyze users influencing other users to perform an action with regards to viral content items, such as news articles about current events, socially-charged commentary on external websites, and the like. Furthermore, information tracked in the label objects may enable the engagement metrics module 504 to determine the effect on user engagement in the social networking system 100 based on how often users repeatedly interacted with highly-viral content items, such as sharing the content items, commenting on the content items, expressing interest in the content items, expressing interest in comments within the content items, and so forth.

A conversion metrics module 506 may analyze information gathered in the label objects as well as information received from external websites 216 regarding user behavior. Traditional conversion tracking could only track conversions one level deep, such as a user that viewed an advertisement for shoedazzle.com being directed to an external website 216 on which the user makes a purchase of shoes. With the information gathered by the social networking system 100 using label objects in the label store 230, conversions on external websites 216 may be attributed to advertisements, status updates, video content, and other content items on the social networking system 100 across several generations of communication. Additionally, the conversion metrics module 506 may determine other conversion metrics that may be valuable information to administrators of the social networking system as well as advertisers, such as identifying users that repeatedly convert on external websites and tracing paths of user actions and content items that led to conversions.

A location metrics module 508 analyzes location-based user actions in the social networking system 100 as well as actions performed outside of the social networking system 100, such as mobile applications that map running workouts with GPS-technology, applications that enable check-ins separate from the social networking system 100, and mapping applications that provide navigational directions. The location metrics module 508 may provide useful location-based metrics, such as identifying the advertisements and/or content items that caused users to create check-in events at physical locations on the social networking system. Using information from external websites 216, the location metrics module 508 may also attribute check-in events at physical locations on the external websites 216 to content items and advertisements on the social networking system 100 based on the information gathered in label objects stored in the label store 230.

In one embodiment, travel plans posted as status updates on the social networking system and photos of places may be attributed to advertisements on the social networking system and page posts by travel-related businesses using the location metrics module 508. The location metrics module 508 may analyze status messages for keywords indicating travel and analyze geographic coordinates embedded in photos posted on the social networking system 100. For example, a user that posts pictures from China and status updates about the Great Wall may influence other users to visit a tourism page about China on the social networking system 100.

A storyteller metrics module 510 analyzes information about users of the social networking system 100 and provides metrics about these users based on the information gathered in label objects stored in the label store 230. One storyteller metric may provide the number of users that created an edge with a content item object on the social networking system. For example, the number of users that shared a link to a website, such as shoedazzle.com, may be determined by the storyteller metrics module 510. Other storyteller metrics may include other information about users performing actions about objects in the social networking system 100, such as demographic information about users sharing video posts made by a page on the social networking system 100, users segmented by interest that commented on news articles, and so forth.

### Pricing Models for Advertisements Based on Tracked Communications

Administrators of the social networking system may generate various pricing models for advertisements based on the information gathered by tracking communications on the social networking system. In one embodiment, reach metrics may be used to price advertisements based on the total number of users reached. In another embodiment, various pricing structures may be implemented for different segments of users reached, such as users reached via organic distribution points including newsfeed distribution, mini-newsfeed distribution, profile, pages, groups, applications, and platform applications. In yet another embodiment, the pricing of an advertisement may vary over time based on the virality rate of the advertisement such that a virality rate of greater than 1, meaning that the likelihood of a user interacting with the advertisement is high, correlates to a higher pricing structure than a virality rate of less than 1, meaning that the likelihood of a user interacting with the advertisement is low. In a further embodiment, information about conversion tracking may be used by the social networking system to optimize ad delivery. This may be achieved by targeting users that convert on advertisements more frequently than other similar users, for example. By optimizing ad delivery based on tracked conversions, pricing for this type of targeting optimization may be increased.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
maintaining a store of label objects, each label object including tracking information about a user performing an action, the tracking information including at least one content impression made on the user prior to performing the action;
maintaining a store of edge objects, each edge object associated with a unique label object in the store of label objects and including information about an action performed by a user of the social networking system;
receiving a request for user actions attributable to a selected content impression;
retrieving a first set of label objects from the store of label objects where each label object of the first set of label objects includes tracking information that includes the selected content impression;
retrieving a second set of label objects from the store of label objects where each label object of the second set of label objects includes at least one label object of the first set of label objects;
retrieving a third set of label objects from the store of label objects where each label object of the third set of label objects includes at least one label object of the second set of label objects;
retrieving edge objects from the store of edge objects associated with retrieved label objects of the first set of label objects, the second set of label objects, and the third set of label objects;
determining an attribution of an action included in each of the retrieved edge objects based on information in the retrieved label objects of the first set of label objects, the second set of label objects, and the third set of label objects and information included in the retrieved edge objects; and
storing the attributions for the selected content impression in the social networking system.

2. The method of claim 1, wherein the selected content impression comprises an advertisement displayed to a user of the social networking system.

3. The method of claim 1, wherein the selected content impression comprises a content item post by a page of the social networking system displayed to a plurality of users that have indicated an interest in the page.

4. The method of claim 1, wherein the selected content impression comprises a content item post by a user of the social networking system displayed to a plurality of other users that are connected to the user in the social networking system.

5. The method of claim 1, wherein determining an attribution of an action included in each of the retrieved edge objects based on information in the retrieved label objects of the first set of label objects, the second set of label objects, and the third set of label objects and information included in the retrieved edge objects further comprises:
defining an attribution scoring model based on predetermined rules and weighted factors;
determining a score for each of the retrieved edge objects based on the information in the retrieved label objects of the first set of label objects, the second set of label objects, and the third set of label objects and information included in the retrieved edge objects; and
determining an attribution of an action included in each of the retrieved edge objects based upon the scores for the retrieved edge objects.

6. A method comprising:
receiving information about an action performed by a user on an object in a social networking system;
gathering at least one advertisement provided to the user within a predetermined time period prior to the action, the at least one advertisement connected to the object in the social networking system;
responsive to a plurality of advertisements connected to the object and provided to the user within the predetermined time period prior to the action, selecting an advertisement of the plurality of advertisements based on an attribution scoring model;
determining the action performed by the user on the object in the social networking system as an effect of the selected advertisement; and
providing the effect of the selected advertisement for display in the social networking system.

7. The method of claim 6, wherein the action performed by the user on the object in the social networking system comprises expressing interest in a page of the social networking system.

8. The method of claim 6, wherein the action performed by the user on the object in the social networking system comprises installing an application on the social networking system.

9. The method of claim 6, wherein the action performed by the user on the object in the social networking system comprises performing a custom open graph action.

10. The method of claim 6, wherein the action performed by the user on the object in the social networking system comprises checking into a physical location represented by the object.

11. The method of claim 6, wherein the action performed by the user on the object in the social networking system comprises interacting with another user on the social networking system.

12. The method of claim 6, wherein the action performed by the user on the object in the social networking system comprises generating content for viewing by other users of the social networking system.

13. The method of claim 6, wherein selecting an advertisement of the plurality of advertisements based on an attribution scoring model further comprises:
defining the attribution scoring model based on predetermined rules and weighted factors;
determining a score for each of the plurality of advertisements based on characteristics of the plurality of advertisements; and
selecting the advertisement of the plurality of advertisements based upon the scores of the plurality of advertisements.

14. A method comprising:
using a plurality of distribution points, providing advertisements to users of a social networking system;
tracking the advertisements provided to the users as a plurality of generations of communications where a first generation of communications causes a second generation of communications, wherein tracking the advertisements further comprises recording the second generation of communications in association with the first generation of communications;
generating tracking metrics for the advertisements; and
generating a pricing model for the advertisements based on the tracking metrics.

15. The method of claim 14, wherein tracking metrics comprise virality metrics for the advertisements that measure rates of replication of the advertisements in the social networking system.

16. The method of claim 14, wherein tracking metrics comprise reach metrics for the advertisements that calculate numbers of users that were influenced by the advertisements across the plurality of generations of communications in the social networking system.

17. The method of claim 14, wherein tracking metrics comprise engagement metrics for the advertisements that calculate engagement levels of users in the social networking system across the plurality of generations of communications as a result of the advertisements.

18. The method of claim 14, wherein tracking metrics comprise conversion metrics for the advertisements that determine rates of conversions by users for the advertisements across the plurality of generations of communications.

19. The method of claim 14, wherein tracking metrics comprise location metrics for the advertisements that provide information about how users were influenced by the advertisements to generate check-in events at physical locations across the plurality of generations of communications.

20. The method of claim 14, wherein tracking metrics comprise storyteller metrics for the advertisements that identify users that published content related to the advertisements on the social networking system.
